(19) United States
(12) Patent Application Publication
(10) Pub. No.: US 2025/0200670 A1
(43) Pub. Date: Jun. 19, 2025

(54) Accounting Platform Advanced Functionalities

(71) Applicant: Ford Squared Technologies LLC, Farmers Branch, TX (US)

(72) Inventor: Stanford C. Baker, Farmers Branch, TX (US)

(21) Appl. No.: 18/642,820

(22) Filed: Apr. 23, 2024

Related U.S. Application Data
(63) Continuation-in-part of application No. 17/174,118, filed on Feb. 11, 2021.
Application No. 17/174,118 is a continuation-in-part of application No. 16/898,286, filed on Jun. 10, 2020, now Pat. No. 10,956,989.
(60) Provisional application No. 63/497,438, filed on Apr. 20, 2023.
(60) Provisional application No. 62/859,969, filed on Jun. 11, 2019.

(51) Int. Cl. G06Q 40/12

(52) U.S. Cl. CPC G06Q 40/123

(57) ABSTRACT

Solutions providing advanced functionalities of an accounting platform. Some solutions enable the use of data not traditionally considered to be accounting-related to perform accounting tasks. Some solutions, for example, can use such non-accounting data to determine (e.g., autonomously) information that is tax-significant. In some cases, the non-accounting data comprises third-party data.

### CROSS-REFERENCES

This application claims the benefit of provisional U.S. Patent Application No. 63/497,438, filed Apr. 20, 2023, by Baker and titled, “Accounting Platform Advanced Functionalities.” This application is also a continuation-in-part of U.S. patent application Ser. No. 17/174,118, filed Feb. 11, 2001 by Baker et al., which is a continuation-in-part of U.S. patent application Ser. No. 16/898,286, filed Jun. 10, 2020 by Baker et al. and issued as U.S. Pat. No. 10,956,989, which claims the benefit of provisional U.S. Patent Application No. 62/859,969, filed Jun. 19, 2019 by Baker et al. The complete disclosure of each of these applications is incorporated by reference herein for all purposes.

This document refers to the above applications collectively as the “Incorporated Applications.”

### BRIEF DESCRIPTION OF THE DRAWINGS

FIG. 1-4 illustrate various methods that can be used to provide advanced functionalities to accounting platforms.

FIG. 5 illustrates a system that can be used to facilitate accounting and tax operations involving net checks to employees.

### DETAILED DESCRIPTION

Some embodiments provide enhanced functionality for an accounting platform, such as one or more of the accounting platforms (which can include any combination of software, hardware, computer systems and/or processes) described in the Incorporated Application. As such, many embodiments can be implemented as software, methods, and/or devices (e.g., computer systems) integrated with and/or operating in conjunction with such accounting platforms. Other embodiments can be implemented separately from such platforms and/or might communicate with an accounting platform via an API, etc.

Some embodiments can also interact and/or incorporate other computing systems, such as the various systems described in the Incorporated Applications as well as payroll systems, government filing and/or recordkeeping systems (within any jurisdiction, at the federal or national level, state or provincial level, and/or local level), to name but a few examples. Such systems can include various tax and/or licensing authorities (e.g., state or local property tax authorities, business licensing authorities) and the like, but can include without limitation any systems that might provide data (including transaction data) that might be relevant to an accounting platform, such as data determined to be tax-significant.

In particular, various embodiments can be implemented in, and/or supplement, the transaction-based workflows described in the Incorporated Applications. Certain embodiments, for example, can collect data from third-party systems (e.g., a third-party payroll system, a government information or filing system, etc.), determine whether that data relates to a tax-significant transaction, and/or incorporate the data into a transaction-based workflow. Certain embodiments can perform some or all of these operations autonomously.

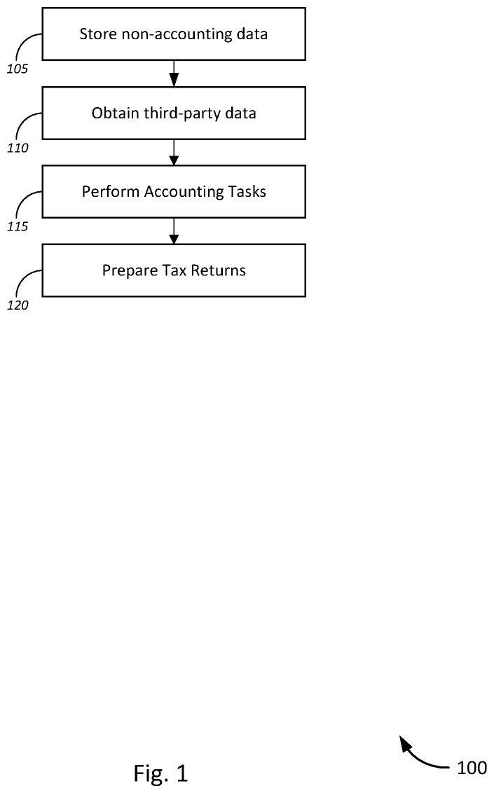

For instance, FIGS. 1-4 illustrate methods that can be performed by a computer system, such as the computer systems 105 and 825 of FIGS. 1 and 8, respectively, of the Incorporated Applications, to name but two examples. Generally, in this document, the term “computer system” and “accounting platform” are used synonymously unless the context dictates otherwise. Moreover the accounting platforms described in The Incorporated Applications can be considered examples of the computer systems and accounting platforms described herein. Similarly, the command centers described in The Incorporated Applications can serve as non-limiting examples of the filing centers described herein. Finally, it should be noted that the methods of FIGS. 1-4 (and/or any of the procedures thereof) are complimentary and can be combined in any appropriate fashion according to various embodiments.

FIG. 1 illustrates a method 100 that enables the use of data not traditionally considered to be accounting-related to perform accounting tasks. At block 105, the method comprises storing non-accounting data. In some embodiments, the term “non-accounting data” is used to describe data that is not directly related to any accounting transactions and is not directly tax-significant. Such data can include, merely by way of example, information about officers of an entity, business identification information about an entity, and/or data about equipment or real property leases or purchases. In some cases, non-accounting data can comprises validation data from one or more audits (such as valuation audits), which could be user to prepare personal property tax returns, to name but one example. As another example, the non-accounting data might include data generated or provided by personnel or contractors of an entity, who are unrelated to an accounting function and/or at tax-accounting function of the entity

In various embodiments, the computer system can use such non-accounting data to determine (e.g., autonomously) information that is tax-significant. Merely by way of example, the computer system might analyze data about real property leases to determine that an entity associated with the leases has begun to engage in business operations in a new jurisdiction (e.g., a new state and/or new locality), which could trigger a requirement to pay taxes and/or file a tax return in that jurisdiction. As described in further detail below, a net check to an employee can be considered non-accounting data in some aspects and is considered as such in this disclosure; for example, while the net amount of the check might be considered a debit on its own, the tax significance generally results from the grossed-up payment, rather than the net payment. In some cases, the non-accounting data comprises third-party data, in which case the method can further comprise obtaining the third-party data from one or more third-party systems (block 110).

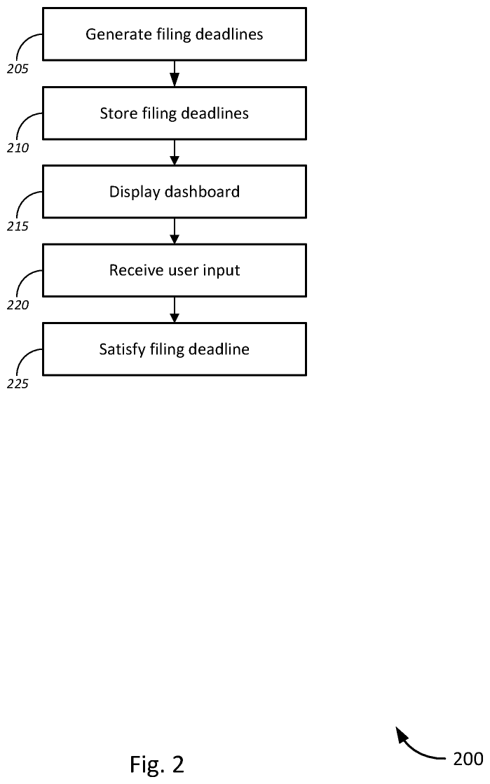

In some embodiments, the method further comprises performing one or more accounting tasks (block 115). In some cases, the performance of these tasks employs the non-accounting information. One such task might be the preparation of a tax return (block 120). Further examples of various tasks that the computer system might perform are described in further detail in connection with FIGS. 2-4.

For instance, FIG. 2 illustrates a method 200 of identifying deadlines and/or completing filings prior to the deadlines. In some cases, the method 200 can be performed by the computer system using non-accounting data. The method 200 might comprise generating, perhaps from non-accounting data (e.g., third-party data), one or more filing deadlines for an entity (e.g., a person, a business or other organization, etc.). Generating a deadline can involve multiple operations, including without limitation, analyzing the non-accounting and/or third-party data, inferring from the analyzed data that an action (e.g., filing a form with a governmental entity) must be accomplished, and/or identifying a date and/or time by which the action must be accomplished. Examples of filings that might be considered actions in various embodiments can include filing tax returns and/or paying taxes (including without limitation federal, state, and/or local franchise taxes, payroll taxes, employer taxes, property taxes, sales taxes, use taxes and/or the like). Other examples of such filings can include business filings (such as annual reports, license applications or renewals, registrations in new jurisdictions, and/or the like).

The method 200 can further comprise storing the deadline (block 210). In some embodiments, the computer system stores the deadline in a filing center of an accounting system. In a particular aspect, a filing center can be a dashboard showing various deadlines, which might be a component of a command center as described in The Incorporated Applications. The filing center, of course, is not limited to any particular implementation. Similarly, while the system can store deadlines generated as described above, it can also store other deadlines, which might be provided by user input, for example by an employee or vendor not associated with an accounting or tax function of the entity.

In some embodiments the computer system can display such a dashboard (or other user interface) showing one or more filing deadlines stored in the filing center for a user (block 215) to educate or remind a user about the deadlines (including without limitations deadlines generated as described above). The method 200 can include receiving user input (block 220) directing the system to accomplish the action associated with the deadline. At block 225, the system perform one or more procedures to accomplish the action, thus satisfying the deadline. The action might be performed in response to user input; conversely, in some cases user input is not required or provided, such that the computer system might perform one or more procedures to satisfy a deadline autonomously.

Such procedures can include providing instructions to a user regarding how to accomplish the action. Such procedures can include generating one or more documents to enable a user to satisfy the filing deadline. Alternatively and/or additionally, the procedures can include the computer system filing one or more documents to satisfy the filing deadline. Such documents can include the requisite document to be filed (such as a tax return, a business registration, etc.). The procedures might the computer system communicating with a third-party system, such as a payroll management system, a governmental computer system, etc.

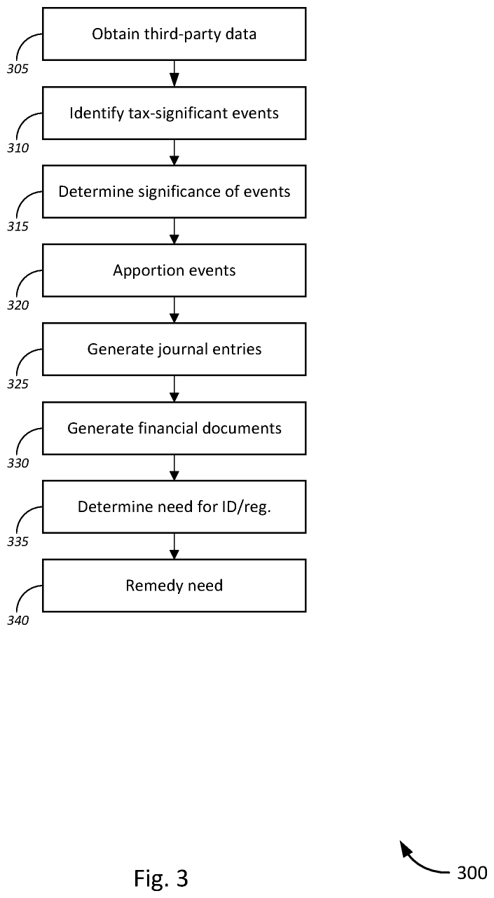

FIG. 3 illustrates other examples of performing an accounting task using non-accounting data, for example by identifying one or more jurisdictions for which the non-accounting data might have tax or business licensing significance and/or apportioning the tax or business licensing significance among multiple such jurisdictions. At block 305, the method 300 comprises obtaining, with a computing system, third-party data from one or more third-party systems.

In some cases, obtaining third-party data from one or more third-party systems comprises receiving data from the one or more third-party systems (which might transmit such data spontaneously and/or in response to a request from the computer system). In other cases, obtaining third-party data from one or more third-party systems comprises accessing the one or more third-party systems to obtain the data. In various embodiments, obtaining third-party data from one or more third-party systems further comprises communicating with the one or more third-party systems using an API, such as a REST API, e.g., to access a third-party system and/or to receive data from such as system, or using any of a variety of other computer-to-computer communication techniques, including without limitation techniques described in the Incorporated Applications. In various embodiments, the third part systems can include systems operated by one or more state and/or local tax authorities, a federal tax authority, a payroll provider, state or local business registration systems, systems operated by corporate service providers, and/or the like.

In some cases, the third-party data can comprise tax data, including without limitation state and/or local income tax data for one or more jurisdictions. Such tax data can include property tax data for one or more jurisdictions, payroll tax data (including without limitation amounts of net checks, as described in further detail below, and/or withholding data, employer tax data, etc.). In some embodiments, therefore, the method 300 can include the computer system identifying, e.g., from the third-party data, one or more tax-significant events for an entity (block 310). In a particular aspect, the method 300 can include determining, with the computer system, that the one or more tax-significant events are significant to a plurality of taxing jurisdictions (block 315), e.g., using various techniques described herein. Merely by way of example, if the third-party data indicates business activities (such as a property lease, an equipment purchase, etc.) in a plurality of jurisdictions, that can indicate that one or more events related to the data might have tax and/or business significance in each of those jurisdictions. Similarly, the addresses of various payees (e.g., employees) in data received (e.g., from a payroll processor's system) might indicate that corresponding payment transactions might have tax significance in multiple jurisdictions corresponding to those addresses.

In some embodiments, the plurality of taxing jurisdictions comprises one or more state jurisdictions and/or one or more local jurisdictions. The method 300 therefore can comprise the computer system apportioning one or more tax significant events (including without limitation the tax significance of those events and/or any tax liability or taxes owed in connection with those events) among the plurality of taxing jurisdictions (block 320). Such apportionment can be based on the data that indicated the tax significance to the different jurisdictions. In some cases, apportioning the one or more tax significant events comprises generating one or more accounting journal entries, tax journal entries and/or reclassifications associated with each of the plurality of taxing jurisdictions (block 325).

In some, the method 300 includes generating, with the computer system, one or more financial documents (block 330). These documents might be generated based on the third-party data and/or the apportionment of the tax significant events. For example, if third-party data and/or the apportionment indicates that an entity is doing business in a particular jurisdiction and entity is not registered in that jurisdiction, the financial documents might include one or more business filings (e.g., business registrations, business licenses, applications for business identifiers, etc.); similarly the data and/or apportionment might trigger one or more tax filings (e.g., tax registrations, tax returns, etc.). Thus, such documents can include, without limitation, tax returns for one or more a plurality of identified taxing jurisdictions, as well as financial statements, financial statement leads, adjusted trial balances, tax trial balances, a tax leads and/or tax returns, as well as other documents described more fully in the Incorporated Applications. The documents can also include any necessary business forms (e.g., registration forms) for filing or documenting the activities of the entity in one or more jurisdictions. These documents and/or any deadlines for filing these documents (and/or making corresponding payments) can be stored in a filing center as described above, and/or the computer system can perform a variety of procedures to accomplish the necessary actions (e.g., filing the generated documents, instructing a user how to do so, etc.), as described above.

For example, the method 300 might include determining, with the computer system, that an entity associated with one or more tax-significant events lacks sufficient identifying or registration information in a jurisdiction and thus needs to file one or more identification or registration documents. (block 335). Such information can include, without limitation, state or local tax identification numbers, state or local business identification numbers, state or local business licenses, and state or local business registrations. In some cases, the computer system can perform one or more procedures to remedy the lack of sufficient identification or registration information in the jurisdiction, such as performing requisite filings (block 340), for example as described above. Merely by way of example, such procedures can include, without limitation, notifying a user of the lack of sufficient identification or registration information, filing one or more documents with at least one of the jurisdictions, preparing a document for a user to file with at least one of the taxing jurisdictions, and/or preparing instructions for a user to follow to remedy the lack of sufficient identification or registration information.

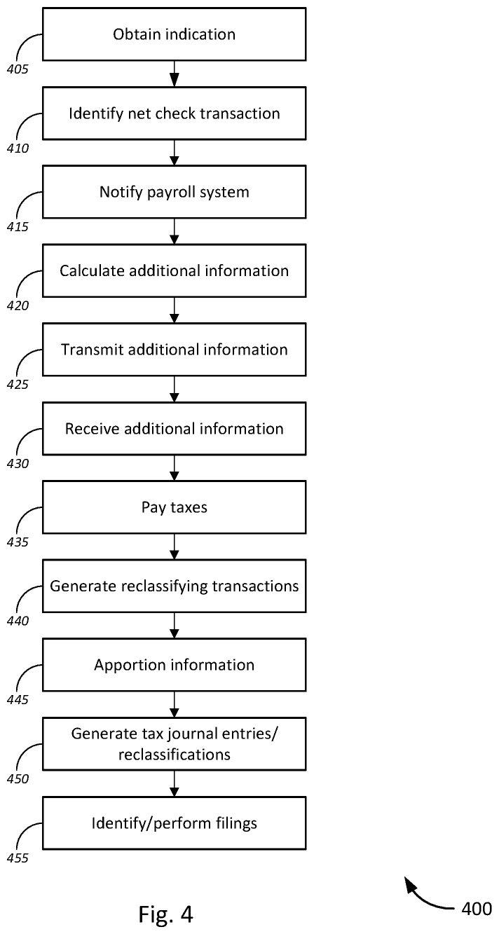

FIG. 4 illustrates a method 400 of performing an accounting task based on third-party information. The method 400 comprises obtaining, at the computer system, an indication of a net check transaction made by an entity (block 405). The transaction might comprise a net check provided by the entity to an employee (i.e., a check in the net amount paid directly to the employee after withholding necessary federal, state, and/or taxes). As noted above, the amount of the net check does not correspond to the true liability or debit to the entity's finances.

In some embodiments, obtaining the indication of the net check can comprise receiving user input at the computer system; the user input might provide the indication data. In other cases, indication might be received as data from one or more third-party systems (which might transmit such data spontaneously and/or in response to a request from the computer system). In other cases, obtaining data (including but not limited to a net check indication) can comprise accessing one or more third-party systems to obtain the data. In various embodiments, obtaining data or notifications from, and/or providing data or notifications to, one or more third-party systems might comprises communicating with the one or more third-party systems using an API, such as a REST API, e.g., to access a third-party system and/or to receive data from such as system, or using any of a variety of other computer-to-computer communication techniques, including without limitation techniques described in the Incorporated Applications.

In particular embodiments, such third-party systems can include, without limitation one or more business accounting systems and/or payroll systems, which might be integrated with the computing system, separate from the computer system, and/or operated by a third party. An example of such a business accounting system is QUICKBOOKS, commercially available from Intuit Corp. An example of a payroll system is a system operated by a payroll provider, such as ADP. Other third-party systems can include government systems, such as systems operated by federal, state, and/or local tax authorities.

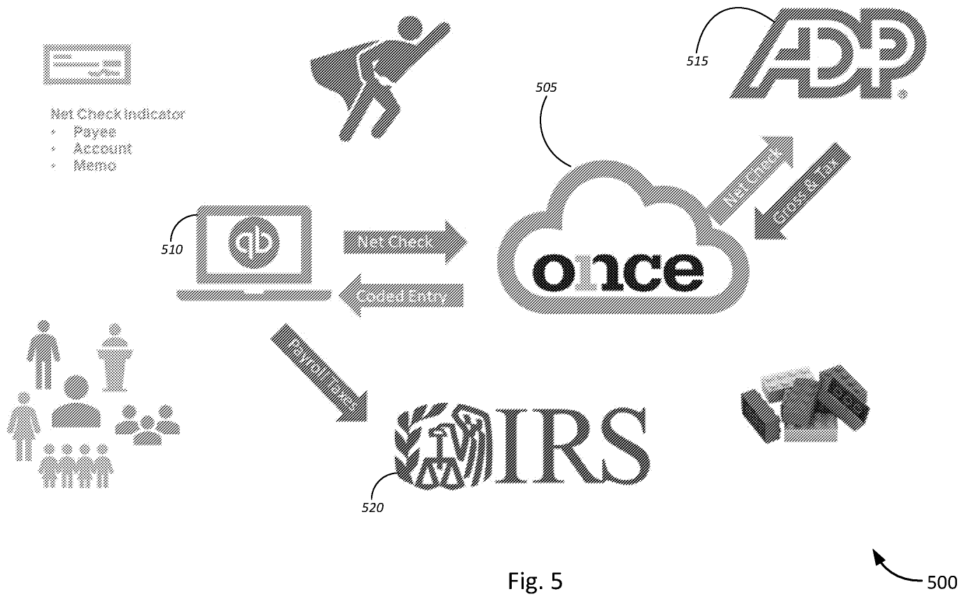

For example, FIG. 5 illustrates a series of transactions between a computer system 505 (e.g., an accounting platform), a third party business accounting system (in this case, QUICKBOOKS) 510, a third-party payroll system 515 (in this case operated by payroll provider ADP), and system 520 operated by a governmental tax authority (in this case, the Internal Revenue Service). In the illustrated example, the business accounting system 510 provides an indication of a net check to the computer system 505. For instance, a user of the business accounting system might have entered the net check transaction directly into the business accounting system 510, which might be configured to provide some or all entered transactions to the computer system 505. Upon receiving the indication, the computer system 505 identifies the transaction as a net check transaction (block410), e.g., by determining that a net check has been issued, based at least in part on the indication.

The indication of a net check transaction can be any of a variety of indicators, including but not limited to an express indication of such by the business accounting system 505. Other, more implied indicators can include indication comprises an amount of the net check transaction (for example, if other transactions in that amount previously have been identified as net check transactions). Additionally and/or alternatively, the indication might comprises one or more of the following: an account to which the net check transaction is coded; a payee of the net check; one or more words of a memo field of the net check; and/or a date on which the net check transaction is posted.

At block 415, the method 400 can include notifying a third-party system (e.g., the payroll system 515 of FIG. 5) of the net check transaction. In some cases, the notification includes an amount of the net check transaction, but this is not required—in other cases, the payroll system 515 (or other third party system) might already have a record of the net check transaction. For example, a payroll system might have provided the amount of the net check transaction to the business accounting system 510 either directly or indirectly (based, for example, on a gross payment amount provided to the payment processor 515). Once the third party system has been notified of the net check transaction, it might back-calculate additional information about the transaction from the amount of the net check (block 420). In other cases, e.g., if the payroll system already has a record of the transaction, such calculation of the additional information might be unnecessary. This additional information might include, for example, a gross amount of the net check transaction and/or one or more amounts of taxes withheld (e.g., federal, state, and/or local withholding) as part of the net check transaction. In some cases, the additional information can comprise one or more amounts of employer taxes owed on the net check transaction. The amount(s) amounts of employer taxes owed might comprise one or more of an amount of federal taxes owed, an amount of state taxes owed to each of one or more states, and/or an amount of local taxes owed to each of one or more localities.

At block 425, the payroll system 515 might transmit this additional information to the computer system 505, which receives the additional information (block 430). At block 435, the method 400 can include paying one or more governmental entities based on the additional information about the net check transaction. In some cases, as shown by FIG. 5 the computer system 505 might autonomously pay the one or more governmental entities based on the additional information about the net check transaction. In other cases, the payroll system 515 or the business accounting system 510 (as shown on FIG. 5) might pay the one or more governmental entities.

In any case, paying one or more governmental entities can comprise paying a federal government 520 amount of federal taxes withheld, paying one or more state governments (not shown on FIG. 5) an amount of state taxes withheld for each of the one or more states, and/or paying one or more local governments (not shown on FIG. 5) an amount of local taxes withheld for each of the one or more localities. Similarly, paying one or more governmental entities might comprise paying a federal government amount of federal employer taxes owed, paying one or more state governments an amount of state employer taxes owed to each of the one or more states, and/or paying one or more local governments an amount of local employer taxes owed to each of the one or more localities.

At block 440, the computer system 505 might generate a reclassifying transaction that reclassifies the net check transaction into a grossed-up amount, based on the additional information received from the payroll system 515. In an aspect, reclassification with the grossed-up amount is effective as of the date of the net check transaction itself was posted, effectively replacing the net check transaction with the grossed-up transaction. This reclassification might include communication (e.g., as described above) between the computer system 505 and the business accounting system 510, such as transmission of a coded journal entry (as shown on FIG. 5).

As noted above, various embodiments can include apportioning taxes between different jurisdictions and/or performing any necessary filings in such jurisdictions based on the apportionment. Thus, the method 400 might include generating one or more tax journal entries or reclassifications to apportion the payment (block 450), e.g., based at least in part on the additional information about the net check transaction. Similarly, if the apportionment provides an indication that filings should be performed in any jurisdictions, the method 400 can include identifying and/or performing any necessary filings (block 455), e.g., using the method described above in conjunction with FIGS. 1-3.

Thus, it should be appreciated once more that various procedures of the methods of FIGS. 1-4 can be combined and/or used together in accordance with various embodiments.

### CONCLUSION

In the foregoing description, for the purposes of explanation, numerous details are set forth to provide a thorough understanding of the described embodiments. It will be apparent to one skilled in the art, however, that other embodiments may be practiced without some of these details. In other instances, structures and devices are shown in block diagram form without full detail for the sake of clarity. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Thus, the foregoing description provides illustration and description of some features and aspect of various embodiments, but it is not intended to be exhaustive or to limit the implementations to the precise form disclosed. One skilled in the art will recognize that modifications may be made in light of the above disclosure or may be acquired from practice of the implementations, all of which can fall within the scope of various embodiments. For example, the methods and processes described herein may be implemented using hardware components, custom integrated circuits (ICs), programmable logic, and/or any combination thereof.

Further, while various methods and processes described herein may be described with respect to particular structural and/or functional components for ease of description, methods provided by various embodiments are not limited to any particular structural and/or functional architecture but instead can be implemented in any suitable hardware configuration. Similarly, while some functionality is ascribed to one or more system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with or without some features for ease of description and to illustrate aspects of those embodiments, the various components and/or features described herein with respect to a particular embodiment can be substituted, added and/or subtracted from among other described embodiments, unless the context dictates otherwise.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods does not limit the implementations unless specifically recited in the claims below. Thus, when the operation and behavior of the systems and/or methods are described herein without reference to specific software code, one skilled in the art would understand that software and hardware can be used to implement the systems and/or methods based on the description herein.

In this disclosure, when an element is referred to herein as being “connected” or “coupled” to another element, it is to be understood that one element can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not preclude other connections, in which intervening elements may be present. Similarly, while the methods and processes described herein may be described in a particular order for ease of description, it should be understood that, unless the context dictates otherwise, intervening processes may take place before and/or after any portion of the described process, and, as noted above, described procedures may be reordered, added, and/or omitted in accordance with various embodiments.

In this application, the use of the singular includes the plural unless specifically stated otherwise, and use of the term “and” means “and/or” unless otherwise indicated. Also, as used herein, the term “or” is intended to be inclusive when used in a series and also may be used interchangeably with “and/or,” unless explicitly stated otherwise (e.g., if used in combination with “either” or “only one of”). Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Unless otherwise indicated, all numbers used herein to express quantities, dimensions, and so forth should be understood as being modified in all instances by the term “about.” As used herein, the articles “a” and “an” are intended to include one or more items and may be used interchangeably with “one or more.” Similarly, as used herein, the article “the” is intended to include one or more items referenced in connection with the article “the” and may be used interchangeably with “the one or more.” As used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. In the foregoing description, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Thus, while each dependent claim listed below may directly depend on only one claim, the disclosure of various implementations includes each dependent claim in combination with every other claim in the claim set. No element, act, or instruction used herein should be construed as critical or essential unless explicitly described as such.

1. A method, comprising:
autonomously obtaining, with a computing system, third-party data from one or more third-party systems;
autonomously identifying, with the computer system, from the third-party data, one or more tax-significant events for an entity; and
autonomously generating one or more accounting journal entries for the entity in the computing system, based at least in part on the identified one or more tax-significant events.

2. The method of claim 1, wherein the tax data comprises state and/or local income tax data for one or more jurisdictions, property tax data for one or more jurisdictions, or payroll tax data.

3. The method of claim 2, wherein the one or more third-party systems comprise one or more systems operated by one or more state and/or local tax authorities.

4. The method of claim 1, further comprising:
autonomously determining, with the computer system, that the one or more tax-significant events are significant to a plurality of taxing jurisdictions.

5. The method of claim 4, further comprising:
autonomously apportioning, with the computer system, the one or more tax significant events among the plurality of taxing jurisdictions.

6. The method of claim 5, wherein apportioning the one or more tax significant events comprises generating one or more tax journal entries or reclassifications associated with each of the plurality of taxing jurisdictions.

7. The method of claim 5, further comprising:
generating, with the computer system, one or more financial documents based on the apportionment of the tax significant events.

8. The method of claim 7, wherein the one or more financial documents comprises a financial statement, a financial statement lead, an adjusted trial balance, a tax trial balance, a tax lead and/or a tax return.

9. The method of claim 3, further comprising:
autonomously determining, with the computer, that an entity associated with the one or more tax-significant events lacks sufficient identification or registration information in at least one of the plurality of taxing jurisdictions.

10. The method of claim 9, further comprising:
autonomously performing, with the computer, one or more procedures to remedy the lack of sufficient identification or registration information, the one or more procedures comprising:
notifying a user of the lack of sufficient identification or registration information; autonomously filing one or more documents with at least one of the taxing jurisdictions;
autonomously preparing a document for a user to file with at least one of the taxing jurisdictions; or
autonomously preparing instructions for a user to follow to remedy the lack of sufficient identification or registration information.

11. The method of claim 4, wherein the plurality of taxing jurisdictions comprise one or more state jurisdictions and/or one or more local jurisdictions.

12. The method of claim 1, wherein obtaining third-party data from one or more third-party systems further comprises communicating with the one or more third-party systems using an API.

13. The method of claim 1, further comprising:
storing, with the computing system, non-accounting data that is not directly related to any accounting transactions and is not directly tax-significant;
autonomously employing, with the computer system, the non-accounting data to perform one or more accounting tasks.

14. The method of claim 1, further comprising:
autonomously generating, from the third-party data, one or more filing deadlines for an entity;
storing, with a computer system, the one or more filing deadlines in a filing center of an accounting system; and
displaying for a user, a user interface comprising a dashboard showing one or more of the filing deadlines stored in the filing center;
receiving input from the user; and
in response to the input from the user, performing, with the computer system, one or more procedures to satisfy one of the filing deadlines.

15. The method of claim 1,
obtaining, at the computer system, an indication of a net check transaction comprising a net check provided to an employee;
autonomously identifying with the computer system the transaction as a net check has transaction, based at least in part on the indication; and
autonomously notifying a payroll system of the net check transaction; and
receiving, at the computer system from the payroll system, additional information about the net check transaction, the additional information comprising a gross amount of the net check transaction.

16. The method of claim 15, wherein obtaining the indication of the net check comprises one or more of the following operations:
receiving the indication at the computer system from a business accounting system, wherein the business accounting system is integrated with the computing system, separate from the computer system, and/or operated by a third party;
accessing a business accounting system with the computer system via an API to obtain the indication, wherein the business accounting system is integrated with the computing system, separate from the computer system, and/or operated by a third party; or
receiving user input at the computer system, the user input providing the indication.

17. The method of claim 15 further comprising:
autonomously paying, by the computer system, a federal government an amount of federal taxes withheld, paying one or more state governments an amount of state taxes withheld for each of one or more states, and/or paying one or more local governments an amount of local taxes withheld for each of one or more localities; and
autonomously paying, by the computer system, the federal government an amount of federal employer taxes owed, paying the one or more state governments an amount of state employer taxes owed to each of the one or more states, and/or paying the one or more local governments an amount of local employer taxes owed to each of the one or more localities.

18. The method of claim 15, further comprising:
autonomously generating, with the computing system, a reclassifying transaction that reclassifies the net check transaction into a grossed-up amount.

19. A system, comprising:
one or more processors; and
a non-transitory computer readable medium having encoded thereon instructions executable by the processor to perform operations comprising:
autonomously obtaining, with a computing system, third-party data from one or more third-party systems;
autonomously identifying, with the computer system, from the third-party data, one or more tax-significant events for an entity; and
autonomously generating one or more accounting journal entries for the entity in the computing system, based at least in part on the identified one or more tax-significant events.

20. An apparatus, comprising:
a non-transitory computer readable medium having encoded thereon instructions executable by one or more processors to perform operations comprising:
autonomously obtaining, with a computing system, third-party data from one or more third-party systems;
autonomously identifying, with the computer system, from the third-party data, one or more tax-significant events for an entity; and
autonomously generating one or more accounting journal entries for the entity in the computing system, based at least in part on the identified one or more tax-significant events.

21-112. (canceled)
